(19) United States
(12) Patent Application Publication
(10) Pub. No.: US 2003/0118022 A1
(43) Pub. Date: Jun. 26, 2003

(54) Reconfigurable data packet header processor

(75) Inventors: Paritosh Kulkarni, San Jose, CA (US); Nirmal Raj Saxena, Los Altos, CA (US)

Correspondence Address: LaRiviere, Grubman & Payne, LLP, P.O. Box 3140, Monterey, CA, 93942, US

(73) Assignee: Chip Engines, Santa Clara, CA

(21) Appl. No.: 10/327,223

(22) Filed: Dec. 20, 2002

Related U.S. Application Data
(60) Provisional application No. 60/343,091, filed on Dec. 21, 2001.

(51) Int. Cl. H04L 12/28

(52) U.S. Cl. 370/392

(57) ABSTRACT

The present invention addresses the need for improved network data handling with a flexible, single point solution for packet header processing of data packets in a variable format transfer environment without associated performance or rate degradation. The present invention introduces a programmable or reconfigurable data packet header processor, wherein various registers (50, 55 and 60) of a chip are selectively programmed with a set of values that map the length (48) and location (44) of various header fields (20, 23, 25) to their position measured from the start of the packet (29). Unlike dedicated hardware solutions, these updateable registers are designed to store length (48), position (44) and type (40) data relating to multiple packet formats to improve extraction of packet header information by guiding the extraction to the exact point of the desired field information.

### RELATED APPLICATIONS

This application claims priority to the provisional U.S. Application No. 60/343,091 filed on Dec. 21, 2001.

### TECHNICAL FIELD

The present invention relates generally to a system and method for improved data transmission over a network. More particularly, the present invention addresses existing challenges with data packet processing. More particularly still, the present invention provides a reconfigurable processing unit for decoding multiformat data packet headers without degradation in the physical link rate performance.

### BACKGROUND ART

Current network technology provides for data packet transmission over a single physical link such as OC-192 or 10G Ethernet, and it is generally understood that processing of data packets at network layer 2 and above will require format specific operations. Data packets generally contain headers; i.e., one or more fields containing information relative to processing and distribution of a particular data packet. Headers contain, for example, fields for the source address and the destination address of the packet. Upon receipt of a packet at an interim hop or destination along a network, a header processor locates certain fields within the header, and extracts information from the selected fields.

Packet headers, however, are not constructed according to a single standard. Data packets are commonly formatted according to a variety of protocols such as 802.3 Ethernet, POS-PPP, IPv4/MPLS, GFP encapsulation, Ethernet in PPP, and RPR. These data protocols encode for data packets with resultant header fields of various types located at various positions within a corresponding data packet header. In the data packet header, the type of field and the position of the field is dictated by the particular protocol used. When data is transmitted over a network in packet form using a particular protocol, a header processor must be able to identify the type and location of the field to be extracted within the header upon receipt of the data packet at interim hops or destination on the network. At relatively low physical line rates such as DS3 and below, software running on a general purpose processor locates and extracts the needed header information. Packets transmitted over physical links with higher rates such as OC-48 and above, however, require special purpose hardware such as network processors or ASICs to accomplish the aforementioned format-specific processing operations. This dedicated hardware increases both work effort and financial expenditures for complex system configuration design and development tasks, hardware acquisition, and so forth. Yet another issue arises in packet processing when the one or more fields in the header are malformed, preventing processing and delivery of the packet data content.

What is needed, therefore, is a single point, comprehensive solution for header processing of packets transmitted according to various network protocols at a lower manufacturing cost than multiple line cards or packet specific hardware presently available. Further, it is desirable to provide such a solution without constraint to selection of physical links and without negative impact to associated system and network component performance, while offering such features as error recovery capabilities.

### DISCLOSURE OF THE INVENTION

The present invention addresses the need for improved network data handling with a flexible, single point solution for packet header processing of data packets in a variable format transfer environment without associated performance or rate degradation. The present invention is designed to more economically address data packet header processing than is presently done by multiple line cards and presently available packet specific hardware. The present invention introduces a programmable or reconfigurable data packet header processor predicated on chip technology, wherein various registers of a chip are selectively programmed with a set of values that map the location of various header fields to their position measured from the start of the packet. Unlike dedicated hardware solutions, these updateable registers are designed to store length, position and type data relating to multiple packet formats. By relying on this protocol specific field location and length information, improved packet header decoding is obtained. Upon receipt of a packet, the header processor easily locates and extracts field content based upon the data protocol used by a particular data packet. By relying on the known header data field properties stored in the register, the packet header processor improves efficiency and performance by extracting only the desired field data at the predetermined header location. Thus, the present invention dispenses with the need for cumbersome, expensive hardware solutions such as multiple line cards and packet format specific hardware, eliminates performance and rate degradation presently associated with header processing activities, and permits maximum and optimal utilization of high-speed carriers.

### BRIEF DESCRIPTION OF THE DRAWINGS

FIG. 1 illustrates a schematic of a packet formatted using an Ethernet protocol;

FIG. 2 illustrates the components of the programmable data packet header characteristics register using the example of an Ethernet packet according to the present invention;

FIG. 3 is a block diagram of a method according to the present invention.

### BEST MODE FOR CARRYING OUT THE INVENTION

One embodiment of the present invention includes a header processor; a set of registers, and a configuration component. The system contemplates any combination of hardware, software, logic circuitry, and system components necessary to carry out the functionality described herein. In addition, the use of the term data is not intended to be limited to numerical data, but can also include but is not limited to encoded voice data, audio data and video data.

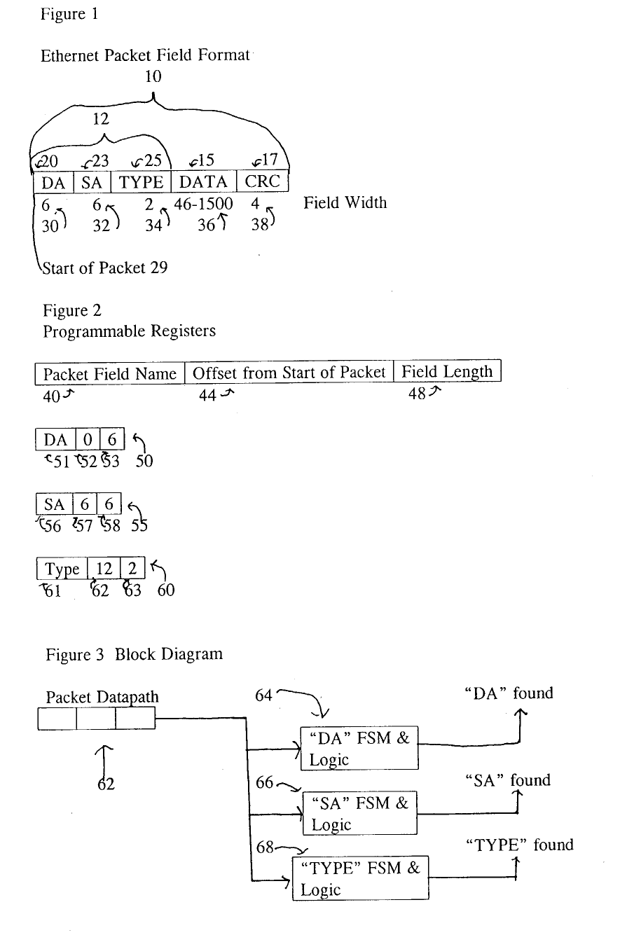

FIG. 1 depicts a typical data packet schematic in accordance with the Ethernet data protocol. The data packet 10 formatted using an Ethernet protocol starts with a start of packet 29 which begins the header 12, followed by data 15 and then the packet terminator CRC 17. The packet header 12 in this example is made up by the destination address field DA 20, start address field SA 23, and type field 25. The relative length of each of these components in bits or bytes is indicated at 30, 32 and 34 respectively, and at 36 for the data 36 and 38 for the packet terminator. For each data packet protocol, the header 12 contains a predetermined set of fields. Since the header characteristics of particular protocols are known, the location of each field in a particular protocol can be identified by its offset, the first byte of the field relative to the start of a particular data packet (byte zero) 29. Consequently, each field 20, 23 and 25 in a data packet header 12 has a specific predetermined length in bits or bytes, and predetermined location in the header measured from the start of packet (SOP) 29 as well.

FIG. 2 depicts a sample programmable register containing a field register 40, an offset register 44, and a length register 48. When a particular field register 40, 44 and 48 is assigned a particular value for use by the header processor (not shown), the field identifier value uniquely identifies the location of specific field within a header 12, such as the destination address field 20. The configuration component (not shown) assigns an offset value 52 to the offset register 44. The offset value numerically represents the location of a particular field within the data packet header 12. The configuration component (not shown) also assigns a length value 53 to a length register 48, the length value 53 representing the length of the associated field in bits or bytes.

The elements of FIG. 2 operate as follows: the first set of registers 50 associated with the Destination Address (DA) field 20 in the Ethernet header example of FIG. 1; a second set of registers 55 associated with the Source Address (SA) field 23; and a third set of registers 60 associated with the Type field 25 in the Ethernet header example of FIG. 1. The first set of registers 50 contains a first field register 51, a first offset register 52, and a first length register 53. The configuration component assigns the field register with a corresponding field value; namely the value DA representative of its associated DA field in the Ethernet packet. The configuration component further assigns the offset register 44 with an offset value; namely, the value “0”, wherein the value “0” indicates the offset of the DA field from the start of the packet (SOP) 29 in the Ethernet packet 10. The configuration component (not shown) assigns the first length register 53 with a length value. In this example, the value “6” indicates the length of the Destination Address 20 field in bytes in the Ethernet packet. Similarly, the set of registers at 55 is associated with the Source Address 23 field in the Ethernet packet example. As shown, the second field register 56 is assigned a value of “SA” to indicate the Source Address field in the Ethernet packet; the second offset register 57 is assigned a value of “6” to indicate a 6 byte displacement from the start of the packet; and the length register 58 is assigned a value of “6” to indicate an SA field length of 6 bytes. The final extractible header field of the Ethernet packet, the Type field 25, corresponds to the set of registers shown at 60, a third field register 60 having a third field value 61 of “Type”, a third offset register 62 having an offset value of“12”, and a third length register 63 having an length value of “2”.

Once the multiple sets of registers 50, 55 and 60 have been assigned, a header processing component (not shown) uses the values of the registers to locate and extract the packet header information. Typically, the processing component comprises a Finite State Machine (FSM) and the associated logic for each field to be extracted; i.e., formal problem resolution reference, as hereinafter illustrated in the block diagram of FIG. 3. In FIG. 3, there is illustrated an Ethernet packet 62 received in by a system for header processing. A Destination Address (DA) FSM 64, a Source Address (SA) FSM 66, and a Type FSM 68 contemporaneously attempt to detect the respective associated field based on the field, offset and length specified in the respective set of registers. Upon detection, the information (data) in the field is extracted and processed. The header processor maintains a running count of the number of bytes from the start of packet 29 and uses the registers as a guide to decode the required field.

If a different packet protocol requires header processing, the registers of the system are merely reprogrammed to reflect the specific field criteria of the new protocol.

Various embodiments of the present invention include an error component to detect packet errors; e.g., malformed packet headers, etc., and take predetermined action such as reporting the error to the CPU.

### INDUSTRIAL APPLICABILITY

The present invention finds industrial applicability in the computer industry. In particular, the present invention relates to industrial applicability in the data network industry. More particularly, the present inventions finds industrial applicability in the data packet header extraction context.

### SCOPE OF THE INVENTION

Having illustrated and described the principles of the system and method of the present invention in various embodiments, it should be apparent to those skilled in the art that the embodiment can be modified in arrangement and detail without departing from such principles. For example, the physical manifestation of the computer media may be changed if preferred. Therefore, the illustrated embodiments should be considered only as example of the invention and not as a limitation on its scope. Although the description above contains much specificity, these should not be construed as limiting the scope of the invention but as merely providing illustrations of some of the presently preferred embodiments of this invention. Further, it is appreciated that the scope of the present invention encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claim. No claim element herein is to be construed under the provisions of 35 U.S.C. 112, sixth paragraph, unless the element is expressly recited using the phrase “means for.”

What is claimed is:

1. A device for improving packetized data routing, comprising the following:
a network data processing means for decoding incoming data packets and extracting desired data fields based upon data packet header characteristics,
a programmable header processor logic block means controlled by said network processing means,
a data register means for storing data packet header characteristics for decoding by said programmable header processor logic block, and
at least one field offset stored for said data packet header characteristics from the start of said data packet.

2. The device of claim 1 wherein said data register means comprises an updateable register means to store additional data packet header characteristics.

3. The device of claim 2 wherein said data packet header characteristics comprise data packet header characteristics for at least one data packet header protocol selected from the group of Resilient Packet Ring, 802.3 Ethernet, POS-PPP, Ipv4/MPLS, GFP encapsulation and Ethernet in PPP.

4. The device of claim 3 wherein said network data processing means further comprises an error handling mechanism to detect and report data packets with erroneous data packet headers.

5. The device of claim 4 wherein said network data processing means further comprises a means for data processing which is capable of sending and receiving data packets over a single physical link at network layer 2 and above.

6. A method for improving network data packet handling comprising the steps of:
storing data protocol specific data packet header field information in a data register,
decoding the header data of an incoming data packet,
determining the data protocol type of said data packet,
extracting desired fields of said data packet header based upon said data protocol specific data packet field header information, and
routing said data packet to its intended destination.

7. The method of claim 6, wherein after said determining the data protocol type step but before the extracting step also comprises the step of retrieving packet header format characteristics from said data register.

8. The method of claim 7 wherein said data packet comprises a data packet encoded with one of the following data protocols selected from the group of Resilient Packet Ring, 802.3 Ethernet, POS-PPP, Ipv4/MPLS, GFP encapsulation and Ethernet in PPP.

9. The method of claim 6 wherein said data register is updateable.

10. A device for improved data header extraction, comprising the following:
a dedicated configuration component means for configuring only packet header characteristics for at least one data protocol, said packet header characteristics including at least header field length, header field location and header field type,
a programmable header processor logic block means controlled by said configuration component means,
a data register means for storing header information for use in header field extraction by said programmable header processor logic block, and
at least one field offset stored for said protocol specific header information, counting said field offset from the start of said data packet.
